(19) United States
(12) Patent Application Publication
(10) Pub. No.: US 2003/0012118 A1
(43) Pub. Date: Jan. 16, 2003

(54) Mechanical transmission of optical pick-up head

(76) Inventors: Steel Su, Taipei (TW); Chieny Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/901,711

(22) Filed: Jul. 11, 2001

(51) Int. Cl. G11B 17/30; G11B 21/02; G11B 17/00; G11B 21/16

(52) U.S. Cl. 369/223; 369/249

(57) ABSTRACT

A mechanical transmission of an optical pick-up head is disposed inside the casing of an optical disk drive for sliding the optical head between a worm shaft and a pressing block, which has a flexible embedded section; wherein the pressing block has a pair of elastic arms and the front end of the elastic arm has an embedded section for embedding the worm shaft; an elastic plate, with one of its end being pressed against the embedding section, and the other end being pressed by the embedded section, by means of the elasticity, the embedded section is also embedded into the worm shaft by elastic pressing. In the sliding movement of the optical head, or the rotating worm shaft brings the embedded section into movement until it ends its journey, the pressing embedded section is detached from the worm shaft. Alternatively, when the worm shaft reverses its rotation, the embedded section will be embedded into the warm shaft again by pressing. Such arrangement allows the optical pick up head of the optical drive to slide in a fast and stable manner.

### BACKGROUND OF THE INVENTION

1. Field of the Invention

The present invention relates to a mechanical transmission of an optical pick-up head, more particularly to an improved mechanical transmission mechanism having an elastic contact pressure, capable of embedding an embedded section of an optical head into a transmission worm shaft by pressing. When the rotating warm shaft brings the embedded section to the end of the journey, the elastic pressing embedded section will be separated from the worm shaft; when the worm shaft rotates in reverse direction, the embedded section will be embedded into the worm shaft again by pressing. Such arrangement can improve the accuracy of the optical pick-up head.

2. Description of the Prior Art

The CD ROM drive is one of the important equipments for computers, which can be used to read different text and graphics data, and video and audio data from the optical disk such as the CD-ROM, DVD, CD-R, and CD-RW. It is unmatched by other traditional disk drives.

Besides the requirements for the access speed, data accuracy is another important index. The known transmission mechanism of the optical pick-up head tries to increase the searching speed for the optical pick-up head, and most designs use a motor and a worm shaft to bring the embedded sliding block of the worm shaft in motion, and also make use of the forward or reverse rotations of the worm shaft to drive the sliding block such that the optical pick-up head can slide back and forth along the sliding block quickly for data search on the surface of the optical disk. However, the tradition design is restricted in a way that when the worm shaft brings the sliding block to the end of the journey, the worm shaft will continue to rotate and produce an interference phenomenon at the embedded sections of both the worm shaft and the sliding block, even when the sliding block reaches the end position. It may easily give rise to a vibration and increase the data searching time; it does not only reduce the stability of the optical disk, but it also influences the accuracy of reading data for the optical pick-up head. It may also cause writing error for the rewritable optical disk drive. Until now, the problems resulted from vibrations have not been resolved yet.

In addition, there is an optical pick-up head having a driving gear which is in contact with the lateral side of the worm shaft. The forward and backward rotations of the worm shaft bring the sliding block of the optical pick-up head to slide back and forth. However, the structure with a contact on the lateral side is not definite and secure at certain period of the time, and it will cause hindrances to the sliding movement of the sliding block, or give rise to reading errors.

### SUMMARY OF THE INVENTION

Therefore, the primary objective of the present invention is to provide a transmission mechanism for an optical pick-up head, having an having an elastic contact pressure to inlay an embedded section of an optical head into the transmission worm shaft by pressing. When the rotating warm shaft brings the embedded section to the end of the journey, the elastic pressing embedded section will be separated from the worm shaft; when the worm shaft rotates in reverse direction, the embedded section will be embedded into the worm shaft again by pressing. Such arrangement can improve the accuracy of the optical pick-up head.

The transmission mechanism of the optical pick-up head according to the present invention is disposed inside the optical disk drive for driving the optical disk to slide between the worm shaft and the pressing block, and has a flexible pressing embedded section. The embedded section is coupled on a pair of elastic arms, and such elastic arm is extended from the pressing block on a lateral side of the optical head so that the embedded section can exactly be embedded to the worm shaft. In addition, the pressing block comprises an elastic plate having one of its end being coupled to the surface of the pressing block, and the other end being pressed into the embedded section for increasing the elastic pressure of the elastic arm. Such arrangement can make use of the elasticity of the embedded section to press and embedded into the worm shaft in order to attain the effect of being stably rotated by the worm shaft and automatically detached at the end of the journey and embedded into the worm shaft again.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows the assembled optical disk drive according to the present invention.

FIG. 2 shows the assembled optical disk drive in FIG. 1 in upside down position to illustrate the transmission mechanism of the optical pick-up head of the present invention.

FIG. 3 is an exploded view of the transmission mechanism of the optical pick-up head according to the present invention.

FIG. 4 shows the partial structure of the transmission mechanism of the optical pick-up head according to the present invention, and illustrates the embedded section being embedded into the worm shaft by elastic pressing.

FIG. 5 is a cross-sectional view of FIG. 4 illustrating the embedding status of the inner edge of the embedded section which is embedded into the protruded teeth and the groves between the threads on the surface of the worm shaft.

### DESCRIPTION OF THE PREFERRED EMBODIMENT

The transmission mechanism for optical pick-up head according to a preferred embodiment of the present invention is disposed inside the interior of casing 11 of an optical disk 10 for sliding the optical head 17 between a worm shaft 21 and a pressing block 25, which has a flexible embedded section.

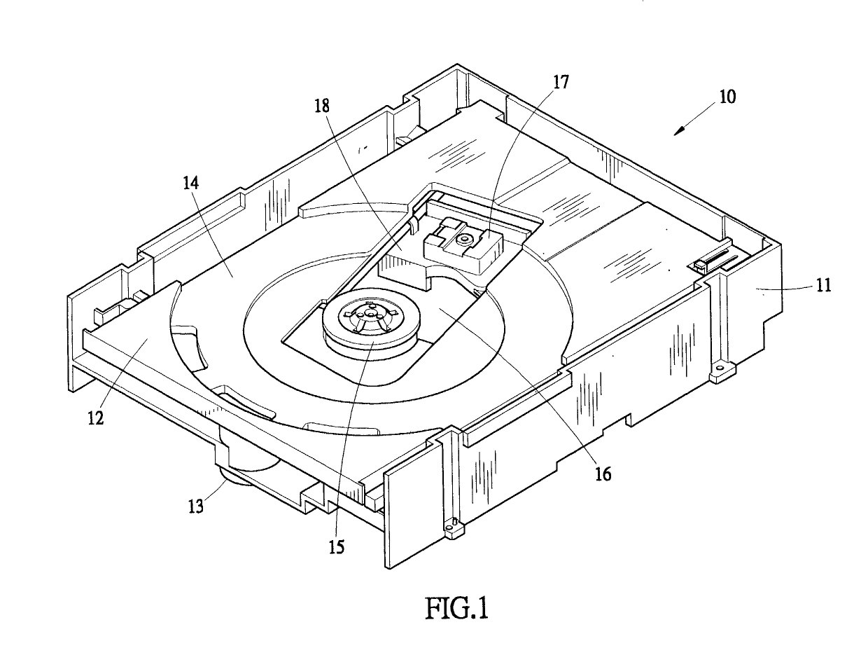

Please refer to FIG. 1, the casing 11 of the optical disk 10 comprises a loader 12 for loading an optical disk (which is not shown in the figure) that can move back and forth. The loader 12 is driven by the first motor 13 in the casing 11 for the back and forth movement. The loader 12 has an inwardly concave circular groove 14 for accommodating the optical disk. A second motor 15 is disposed at the axle position of the circular groove 14. The second motor 15 is protruded from an inclined groove 16 on the surface of the circular groove 14 fro driving the optical disk into rotation. The inclined groove 16 on the circular groove 14 is for the optical pick-up head and the sliding block 18 to slide along the inclined groove 16 in order to read data from the surface of the optical disk.

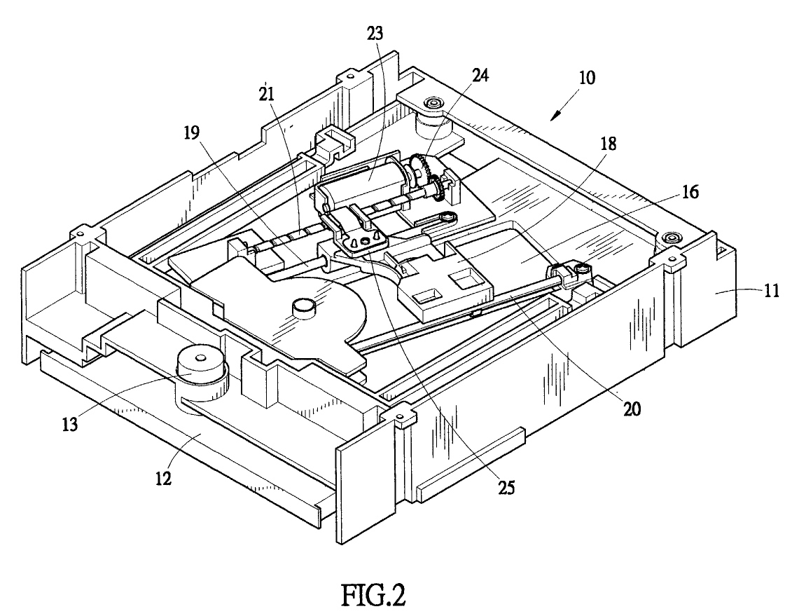

In FIG. 2, it shows the upside down of the optical disk 10 as shown in FIG. 1, and illustrates a optical pick-up head 17 and a sliding block 18 of the transmission mechanism. The sliding block 18 shown in the figure is disposed between two sliding rods 19, 20 on the casing 11. A pressing block 25 is fixed on the side of the sliding block 18, and being embedded to a worm shaft 21 by the elastic pressing embedded section. By the rotation of a third motor 23 via the gear set 24, the worm shaft 21 is brought into rotation. It brings the sliding block 18 to slide back and forth along the two sliding rods 19, 20 by through the elastic pressing embedded section, such that the optical pick-up head 17 on the surface of the sliding block 18 can read data from the surface of the optical disk.

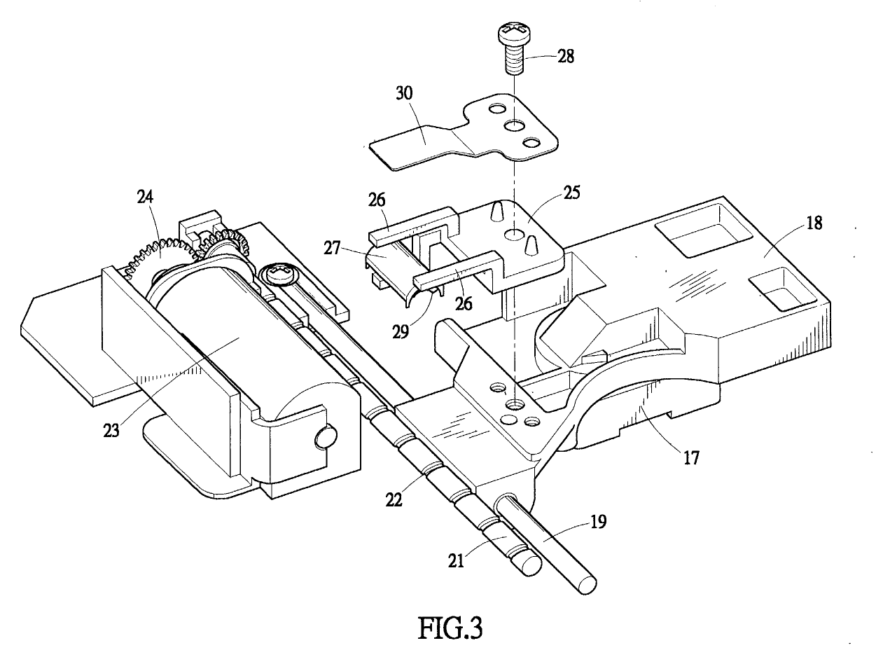

FIG. 3 is an exploded view of the transmission mechanism of the optical pick-up head according to the present invention. The embedded section of the elastic pressing embedded section comprises a pressing block 25 and an elastic plate 30 fixed by a screw rod 28 onto the sliding block 18.

In FIGS. 3, 4 and 5, the pressing block 25 comprises a pair of elastic arms 26 integrally coupled to a lateral side of the pressing block 25, an arced embedded section 27 being disposed at the end of the two elastic arms 26. The curved edge of the inner surface of the arced embedded section 27 has embedded teeth 29, and the embedded teeth 29 are capable of being embedded into the groove 22 of the thread on the surface of the worm shaft 21. After the worm shaft is screwed, the embedded section 27 can exactly locate on the surface of the worm shaft 21 to form the embedded pressing condition.

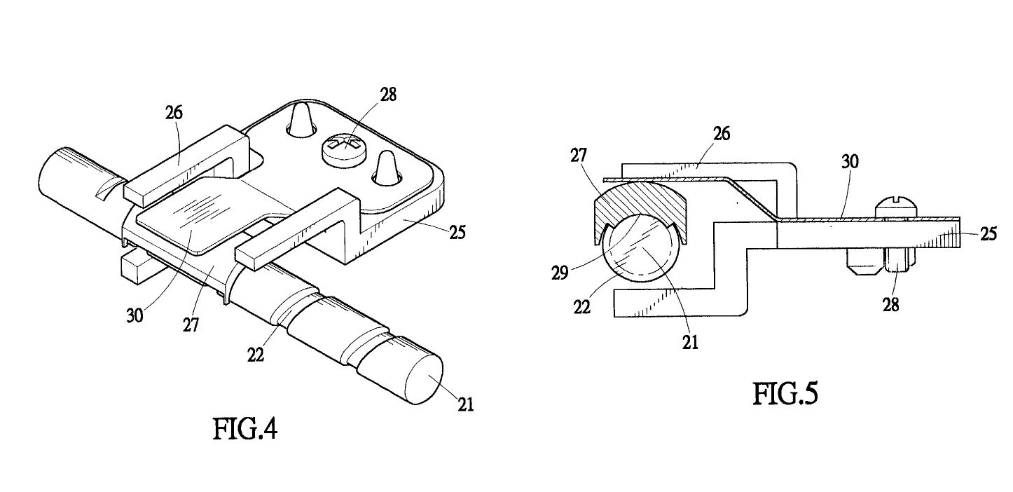

To increase the elastic pressure of the worm shaft 21 with respect to the embedded section 27, an elastic plate 30 is disposed on the surface of the pressing block and the elastic plate 30 is fixed onto the surface of the pressing block by the screw rod 28. The other end of the elastic plate 30 is pressed into the embedded section 27 such that the embedded section 27 will be embedded into the worm shaft by the elastic pressing as shown in FIGS. 4 and 5.

When the third motor 23 rotates and the gear set 24 brings the worm shaft 21 to rotate in forward and reverse directions, the arced embedded section 27 of the pressing block 25 is elastically pressed and embedded into the worm shaft 21 in the elastic pressing embedded section. The sliding block 18 will bring the optical pick-up head to move back and forth along the sliding rods 19 and 20 such that the optical pick-up head 17 can read data from the surface of the optical disk.

Furthermore, when the rotating worm shaft 21 brings the embedded section 27 to the utmost end of the journey, since the embedded section 27 and the worm shaft 21 are elastically pressed and embedded together, therefore the embedded teeth 29 at inner edge of the embedded section 27 can be separated from the threaded groove 22 on the surface of the worm shaft 21, which will not give rise to the interference phenomenon. Alternatively, when the worm shaft 21 rotates in reverse direction, the pressing elasticity makes the embedded teeth 29 at the inner edge of the embedded section 27 to be mutually embedded into the surface of the worm shaft 21 again so that the optical pick-up head can quickly and stably slide.

The elastic contact pressure should be adjusted to extent that the embedded section can be embedded into the worm shaft successfully, but when it rotates in reverse direction, the embedded section can successfully slide back to couple with the threaded groove on the surface of the worm shaft.

We know from the above that the transmission mechanism of the optical pick is designed to have elastic contact pressure such that the embedded section of the sliding block of the optical pick-up head can be embedded and transmitted onto the worm shaft by the pressing. When the rotating worm shaft brings the embedded section to the end of the journey, the elastic pressing embedded section can separate from the worm shaft. Alternatively, when the worm shaft rotates in reverse direction, the embedded section is embedded by pressing into the worm shaft again. It will not give rise to an interference phenomenon, improves the accuracy of the transmission of the optical pick-up head, and thus attain the predetermined purpose.

What is claimed is:

1. A transmission mechanism for an optical pick-up head of an optical disk drive disposed in the interior of a casing of the optical disk drive for sliding the optical head between a worm shaft and a pressing block, comprising: a flexible pressing embedded section; when the optical pick-up head slides, the rotating worm shaft brings the embedded section to the utmost end of the journey; and a elastic pressing embedded section separates from the worm shaft; when the worm shaft rotates in reverse direction, the embedded section will be pressed and embedded into the worm shaft again; characterized in that:
the elastic pressing embedded section comprises a pressing block which has a pair of elastic arms being integrally coupled to a lateral side of the pressing block; an elastic plate jointly fixed on the sliding block by a screw rod,; an arced embedded section disposed at an end of the elastic arm; embedded teeth disposed in the inner edge of the arc surface of the arced embedded section and embedded in the threaded groove on the surface of the worm shaft;
after the screw rod is screwed, the embedding locates exactly on the surface of the worm shaft and produces the pressing embedded condition; the elastic plate is fixed onto the surface of the pressing block by the screw rod such that the other end of the elastic plate is pressed into the embedded section and the embedded section can be embedded into the worm shaft by the elastic pressing.

2. A transmission mechanism for an optical pick-up head of an optical disk drive as claimed in claim 1, wherein said elastic pressing embedded section adjusts the pressure to securely embed the embedded section into the worm shaft; when the worm shaft rotates in reverse direction, the embedded section can slide back and couple with the threaded groove on the surface of the worm shaft.
